(19) United States
(12) Patent Application Publication
(10) Pub. No.: US 2015/0303430 A1
(43) Pub. Date: Oct. 22, 2015

(54) Use of a Silica-Based Powder

(71) Applicant: SAINT-GOBAIN CENTRE DE RECHERCHES ET D'ETUDES EUROPEEN, Courbevoie (FR)

(72) Inventors: Caroline LEVY, Paris (FR); Nabil NAHAS, Serris (FR); Yves BOUSSANT-ROUX, Montfavet (FR)

(73) Assignee: SAINT-GOBAIN CENTRE DE RECHERCHES ET D'ETUDES EUROPEEN, Courbevoie (FR)

(21) Appl. No.: 14/648,759

(22) PCT Filed: Nov. 29, 2013
(86) PCT No.: PCT/IB2013/060515

§ 371 Date: Jun. 1, 2015

(30) Foreign Application Priority Data
Nov. 30, 2012 (FR) 1261459

(51) Int. Cl. H01M 2/16; C04B 35/14; H01M 2/14

(52) U.S. Cl. CPC H01M 2/1686; H01M 2/1646; H01M 2/145; C04B 35/14; H01M 10/052

(57) ABSTRACT

The invention relates to the use of a ceramic-oxide powder for the production of a separator element for a lithium-ion battery, said ceramic-oxide powder having the following chemical composition, in percentages on the basis of the weight of the ceramic oxides, making up a total of 100%: SiO2>85%, Al2O3<10%, ZrO2<10%, other ceramic oxides<5%; said ceramic-oxide powder having a specific surface area of less than 40 m2/g and more than 5 m2/g; said oxide powder having a sphericity index of more than 0.8.

### TECHNICAL FIELD

The invention relates to a novel use of a silica-based powder, namely a use for manufacturing a separation element of a lithium-ion battery. The invention also relates to a separation element thus obtained and to a lithium-ion battery incorporating such a separation element.

### PRIOR ART

Batteries are commonly used as energy sources, notably in portable electronic devices (telephones, computers, still cameras and movie cameras), but also in electric vehicles. Among the batteries, mention may notably be made of lithium-ion batteries.

These batteries are generally composed of an electrolyte, an anode and a cathode, the two electrodes being physically separated from one another in order to avoid any short-circuit. The barrier for separating the anode and the cathode is produced with one or more separation elements, conventionally a separator, optionally coated with a separator coating, or an electrode coating applied to one or both electrodes.

US 2012/015232, US 2007/117025 and US 2012/094184 describe examples of separation barriers.

The separation barrier must have a high ion permeability, a good mechanical strength, and a high stability with respect to the products used in the battery, notably the electrolyte.

In general, the separator consists of one or more layers of polymers, the total thickness of which is typically from several microns to several tens of microns. One or more of the separator layers may also comprise particles of an inorganic material, for example of alumina or of silica, as described for example in U.S. Pat. No. 6,627,346. These inorganic particles are added either as a coating at the surface of the separator, or in the form of filler in the polymer forming one or more separator layers in order notably to improve the mechanical strength of the separator under conditions of high temperatures (notably in the case of runaway of the battery) or impacts, notably in batteries of large volume, composed for example of several cells, or requiring high energy densities.

However, when the separator comprises silica, its resistance to corrosion by the electrolyte may be reduced, which limits the service life of the lithium-ion battery.

There is therefore a need for a lithium-ion battery comprising a separation element that comprises silica and that has a greater service life.

One object of the invention is to at least partially meet this need.

### SUMMARY OF THE INVENTION

According to the invention, this objective is achieved by the use, for the manufacture of a separation element of a lithium-ion battery, of a ceramic oxide powder having the following chemical analysis, as percentages on the basis of the mass of the ceramic oxides and for a total of 100%:
SiO₂>85%
Al₂O₃<10%
ZrO₂<10% other ceramic oxides<5%.

This process is noteworthy in that said oxide powder has a specific surface area (preferably measured by the BET method) of less than 40 m²/g and greater than 5 m²/g.

As will be seen in greater detail in the remainder of the description, the inventors have discovered that such an oxide powder improves the resistance to corrosion by the electrolyte. Furthermore, they observed that such an oxide powder improves the dispersibility of the oxides in the starting feedstock and the shapeability of the separation element, and in particular of the separator.

Preferably, the oxide powder also comprises one, and preferably several, of the following optional features:
The oxide powder preferably has a moisture content, measured after drying at 100° C. for 4 hours, of less than 3%, of less than 2%, preferably of less than 1.5%, preferably of less than 1%, preferably of less than 0.8%, preferably of less than 0.5%, preferably of less than 0.4%, or even of less than 0.3%, or even of less than 0.1%. Advantageously, the corrosion resistance is further improved thereby.
The oxide powder has an SiO₂+Al₂O₃+ZrO₂ content of greater than 90%, preferably of greater than 93%, preferably of greater than 95%, preferably of greater than 97%, or even of greater than 98%, as percentages on the basis of the mass of the oxides.
The oxide powder has an SiO₂ content of greater than 87%, preferably of greater than 88%, or even of greater than 89% and/or of less than 99.8%, or even of less than 99%, or even of less than 98%, or even of less than 95%, as percentages on the basis of the mass of the oxides.
The oxide powder has an Al₂O₃ content of greater than 0.05%, or even of greater than 0.2%, or even of greater than 0.5%, or even of greater than 1%, or even of greater than 2%, or even of greater than 3% and/or of less than 8%, preferably of less than 6%, or even of less than 5%, as percentages on the basis of the mass of the oxides.
The oxide powder has a ZrO₂ content of greater than 0.05%, or even of greater than 0.5%, or even of greater than 1%, or even of greater than 2%, or even of greater than 3%, or even of greater than 4% and/or of less than 8%, preferably less than 6%, as percentages on the basis of the mass of the oxides.
The oxide powder has a content of “other ceramic oxides” of less than 4%, preferably of less than 3%, preferably of less than 2%, preferably of less than 1%, or even of less than 0.5%, or even of less than 0.1%, as percentages on the basis of the mass of the oxides.
The sum Fe₂O₃+Na₂O +CaO +P₂O₅ represents more than 80%, or even more than 90% of said “other ceramic oxides”, as percentages on the basis of the mass of the oxides.
The oxide powder has an Fe₂O₃ content of less than 0.5%, preferably of less than 0.3%, preferably of less than 0.2% or even of less than 0.1%, as percentages on the basis of the mass of the oxides.
The oxide powder has a P₂O₅ content of less than 0.5%, preferably of less than 0.3%, preferably of less than 0.2% or even of less than 0.1%, as percentages on the basis of the mass of the oxides.
The oxide powder has a content of metallic iron of less than 0.1%, or even of less than 0.05%, or even of less than 0.01%, or even of less than 0.001%, as percentages on the basis of the mass of the oxide powder.
The oxide powder has a content of free carbon of less than 0.5%, preferably of less than 0.1%, or even of less than 0.05%, as mass percentages on the basis of the mass of the oxide powder.
The oxide powder has a content of silicon carbide of less than 0.5%, preferably of less than 0.1%, or even of less than 0.05%, or even of less than 0.01%, as mass percentages on the basis of the mass of the oxide powder. The oxide powder has a specific surface area of less than 30 m²/g, preferably of less than 20 m²/g, preferably of less than 15 m²/g.
The oxide powder has a sphericity index of greater than 0.8, preferably of greater than 0.85, or even of greater than 0.9. Advantageously, the use of said powder is improved thereby.
Less than 10%, preferably less than 5%, preferably less than 1%, by mass of the silica of said oxide powder is crystalline, the balance being in an amorphous phase. In one embodiment, the silica of said oxide powder is substantially all in an amorphous form.
The relative density of said oxide powder is greater than 98% of the absolute density, or even greater than 99%, or even greater than 99.5% of the absolute density.
The oxide powder has a D_{99.5} percentile of less than 10 μm, preferably of less than 8 μm, preferably of less than 5 μm, more preferably of less than 2 μm.
The oxide powder has a D₉₀ percentile of less than 8 μm, preferably of less than 5 μm, preferably of less than 2 μm, more preferably of less than 1 μm.
The oxide powder has a D₅₀ percentile of less than 2 μm, preferably of less than 1 μm, preferably of less than 0.8 μm, preferably of less than 0.5 μm and preferably of greater than 0.05 μm, preferably of greater than 0.1 μm.
The oxide powder has a (D₉₀-D₁₀)/D₅₀ ratio of less than 10, or even of less than 5.
The oxide powder has an untapped density of greater than 0.2 g/cm² and/or less than 1 g/cm².
In one embodiment, the surface of the oxide powder is functionalized, for example in order to render said powder hydrophobic, or to improve its dispersion in the polymer, for example by using grafting based on silane or siloxane or hexamethyldisilazane.

The separation element may in particular be a separator and/or a separator film and/or a separator coating and/or an electrode coating of a device according to the invention, as described below.

The invention also relates to a device selected from a separator, a separator film that is part of a separator consisting of a superposition of several films, a separator coated with one or more separator coatings, an anode coated with an electrode coating and a cathode coated with an electrode coating,
the separator (whether it is coated or not) or the separator film, and/or
the separator coating and/or
the electrode coating
   (generically “the separation element”) having, after calcining at 500° C. for 2 hours, the following chemical analysis, as percentages on the basis of the mass of the ceramic oxides and for a total of 100%:
SiO₂>85%
Al₂O₃<10%
ZrO₂<10%
other ceramic oxides<5%,
   and being noteworthy in that it comprises particles of these oxides and that the specific surface area of the particles of these ceramic oxides is less than 40 m²/g and greater than 5 m²/g.

Such a separation element is described as a separation element “according to the invention”.

The invention also relates to a lithium-ion battery comprising an anode and a cathode, taken as a whole “the electrodes”, and a separation barrier positioned between the anode and the cathode, said separation barrier comprising a separator optionally comprising several separator films, and, optionally, one or more coatings applied to the separator and/or to the anode and/or to the cathode so as to separate the anode and the cathode, at least one separation element selected from the group formed by said separator, said separator film, and the separator and/or electrode coating(s) being a separation element according to the invention.

The invention also relates to a process for manufacturing a lithium-ion battery comprising an anode, a cathode and a separation barrier between the anode and the cathode, the separation barrier comprising a separator, optionally one or more separator coatings applied to the separator and optionally one or more coatings applied to the anode and/or to the cathode so as to separate the anode and the cathode, at least one separation element selected from the group formed by the separator, a film of said separator, and the separator and/or electrode coating(s) being according to the invention.

### Definitions

The expression “size of a particle” is understood to mean the size of a particle given conventionally by a particle size distribution characterization carried out with a laser particle size analyzer. The laser particle size analyzer used here is a Partica LA-950 from HORIBA.
The 10 (D₁₀), 50 (D₅₀), 90 (D₉₀) and 99.5 (D_{99.5}) percentiles or “centiles” are the sizes of particles corresponding to the percentages, by mass, of 10%, 50%, 90% and 99.5% respectively, on the cumulative particle size distribution curve of the sizes of particles of the powder, the sizes of particles being classified in increasing order. For example, 10%, by mass, of the particles of the powder have a size of less than D₁₀ and 90% of the particles by mass have a size of greater than D₁₀. The percentiles may be determined with the aid of a particle size distribution produced using a laser particle size analyzer.
The expression “maximum size of the particles of a powder” refers to the 99.5 (D_{99.5}) percentile of said powder.
The sphericity index of a powder of particles is the mean sphericity index of the particles of said powder (arithmetic mean), the sphericity index of a particle being equal to the ratio between its smallest diameter and its largest diameter. Any known measurement method may be envisaged, and notably laser particle size analysis or observation of photographic images of the powder.
The “untapped density” of an oxide powder may be measured after having filled a defined volume with this powder, without tapping said powder, by dividing the mass poured in by said volume.
Unless otherwise indicated, a mean is an arithmetic mean.
Unless otherwise indicated, all the percentages relating to the composition of a separation element are percentages by mass on the basis of the ceramic oxides, after calcining at 500° C. for 2 hours, so as to eliminate the organic constituents.

### BRIEF DESCRIPTION OF THE FIGURES

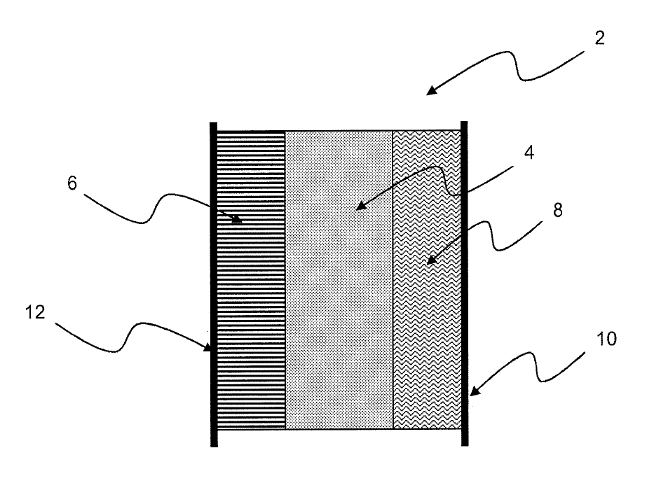

Other objects, aspects, properties and advantages of the present invention will also emerge in the light of the description and of the examples that follow and on studying the appended drawing in which FIG. 1 represents, in transverse cross section, a portion of a battery according to the invention equipped with a separation barrier between the electrodes (in this particular case in the form of a separator).

### DETAILED DESCRIPTION

FIG. 1 represents a portion of a battery 2, consisting of a separation barrier 4, an anode 6, a current collector 12 at the anode, a cathode 8 and a current collector 10 at the cathode. The anode 6, the cathode 8 and the separation barrier 4 are immersed in the electrolyte, the current collectors 10 and 12 being in contact with the electrolyte. The anode 6 and the cathode 8 constitute the electrodes.

The material used as anode material is preferably selected from graphite, a titanate, preferably a lithium titanate, or a silicon-based compound selected from Si, SiOₓ, 0<x<2, it being possible for said silicon-based compound to optionally be mixed with a carbon-based compound, such as for example graphite.

The material used as cathode material is probably selected from LiCoO₂, LiMnO₂, LiMn₂O₄, LiFePO₄, LiNiO₂, it being possible for these materials to optionally comprise one or more dopants, as in LiMn_{0.8}Fe_{0.2}PO₄ or LiNi_{1/3}Mn_{1/3}Co_{1/3}O₂.

The electrolyte is preferably a solution comprising an organic solvent based on carbonates, esters and/or ethers, the solvent preferably being selected from ethylene carbonate, propylene carbonate, butylene carbonate and diethyl carbonate, dissolved in which solvent is a compound preferably selected from LiFP₆, LiBF₄, LiClO₄, LiCF₃SO₃, LiN(SO₂CF₃)₂, LiN(SO₂C₂F₅)₂, LiAlCl₄, LiB OB, and mixtures thereof.

The separation barrier 4 consists of a separator, and, optionally,
a separator coating extending over one or both large faces of the separator, preferably covering it (them) completely, and/or
an electrode coating extending over one or both electrodes, preferably covering it (them) completely.

According to the invention, at least one separation element, i.e. an element selected from the separator (or a separator film), the separator coatings and the electrode coatings, preferably all the separation elements constituting the separation barrier, has (have), after calcining:

a composition such as, as percentages on the basis of the mass of the ceramic oxides and for a total of 100%:
SiO₂>85%
Al₂O₃<10%
ZrO₂<10%
other ceramic oxides<5%,
   a specific surface area of the particles of these oxides of less than 40 m²/g and greater than 5 m^{2/}g.

The specific surface area of the particles of these oxides may be easily evaluated by measuring, according to the BET (Brunauer Emmet Teller) method as described in The Journal of the American Chemical Society 60 (1938), pages 309 to 316, the specific surface area of the powder used as raw material. Indeed, the known processes for manufacturing said separation element do not substantially modify the shape of the oxide particles when they are assembled in order to form said element.

The vast majority of the powders sold having a chemical analysis in accordance with that of the powder used according to the invention and having a specific surface area of less than 40 m²/g and greater than 5 m²/g have a moisture content of less than 3% after drying at 100° C. for 4 hours. Furthermore, a person skilled in the art knows how to reduce this moisture content, notably to a value of less than 3%. A heat treatment in air at a temperature of between 400° C. and 500° C., with a hold time at this temperature of more than 2 hours, is one of the means that makes it possible to reduce the moisture content of the oxide powder. Another means consists in subjecting the oxide powder to a heat treatment under vacuum, at a pressure of less than 10⁻¹ Pa, at a temperature between 110° C. and 300° C., for a time typically equal to 5 hours.

The moisture content may be measured as described in the examples.

The open porosity of the separation element, in particular when the separation element is a separator, is preferably greater than 20%, preferably greater than 30%, preferably greater than 40%, preferably greater than 50% and less than 90%, preferably less than 80%, preferably less than 70% of the volume of said separation element.

Generally, a separation element according to the invention may in particular be manufactured in accordance with a process according to which
A) a starting feedstock is prepared by adding thereto an oxide powder as defined above,
B) said starting feedstock is shaped so as to form said separation element.

The starting feedstock preferably comprises more than 0.1%, preferably more than 1%, preferably more than 5%, preferably more than 10%, preferably more than 20%, or even more than 40% and less than 90%, or even less than 80%, or even less than 70% of said oxide powder, as a mass percentage on the basis of said starting feedstock.

The oxide powder may be agglomerated, for example in the form of granules, in order to favor its introduction into the starting feedstock.

The starting feedstock, in particular the starting feedstock going into the manufacture of a separator and/or of a separator film, preferably comprises a polymer. The polymer is preferably selected from the group formed by polyacrylonitriles, polyamides, polyesters, celluloses, and mixtures thereof, preferably selected from the group formed by polyethylene terephthalate, fluoropolymers and polyolefins, and mixtures thereof, preferably selected from the group formed by polyethylene terephthalates, polytetrafluoroethylenes (or PTFEs), polyvinylidene fluorides (or PVDFs), polypropylenes, polyethylenes, polyoxypropylenes, and mixtures thereof.

A separator may be manufactured according to any technique known from the prior art, such as for example as described in U.S. Pat. No. 6,627,346 or in JP2000208123.

In particular, the separator may be manufactured using a process comprising the following steps:
a) preparation of a suspension by mixing polymers, optionally additives for generating the porosity, such as for example an oil, and an oxide powder;
b) extrusion of the suspension so as to form a film, at a temperature above the melting temperature of the polymer, in general 20° C. to 60° C. above said temperature;
c) preferably, heat treatment of the extruded film so as to increase the crystallinity and the orientation of the polymer;
d) creation of porosity in said extruded film, and optionally heat treatment;
e) optionally, drying of the porous film obtained.

In step c), the heat treatment temperature depends on the nature of the polymer used. For example, for a polypropylene film, a heat treatment at a temperature between 110° C. and 160° C. and applied for a duration of between 3 seconds and 200 seconds is highly suitable.

In step d), the porosity may result, for example, from an extraction or an elimination of the additive. Other methods, for example a film stretching method, can also be carried out.

The separator may consist of several superposed porous films thus manufactured. These films may be prepared independently and hot pressed. The number of films may typically be between 1 and 5. For example it may comprise three superposed films.

Preferably, the separator comprises a separator film according to the invention which extends substantially at the centre of said separator, in particular along a median plane of said separator.

The separator preferably has a thickness of greater than 5 μm and less than 100 μm, or even of less than 50 μm, or even of less than 30 μm, or even of less than 20 μm.

In one preferred embodiment, the silica is distributed substantially uniformly in the volume of said separator.

A separator coating may be manufactured and applied to the separator according to any technique known from the prior art.

In particular, a separator coating may be manufactured using a process comprising the following steps:
i—preparation of a slip comprising the oxide powder, a solvent and a binder,
ii—deposition of said slip at the surface of the separator, according to any technique known to a person skilled in the art, for example screen printing, the doctor blade process, tape casting or slip casting, with a deposition thickness generally of between 1 and 560 μm, preferably of between 2 and 10 μm,
iii—drying.

In step i, the binder used may notably be a resin, an ester, such as a polyethyl acrylate ester, a polyvinyl acetate, a polyethylene, a polypropylene or a fluoropolymer such as polyvinylidene fluoride (PVDF).

The solvent may for example be water, N-methyl-2-pyrrolidone (or NMP), acetone, xylene or chloroform.

The slip may also contain agents making it possible to adjust the viscosity, as a function of the deposition process used. In one embodiment, the slip does not contain such agents.

The separator coating preferably has a thickness of greater than 1 μm, or even of greater than or equal to 3 μm or even of greater than or equal to 5 μm and less than 15 μm, or even of less than 10 μm, or even of less than 8 μm.

In one embodiment, the separator, preferably according to the invention, comprises first and second large faces covered by first and second separator coatings according to the invention, respectively.

A process identical to that described above for the manufacture of a separator coating may be used to manufacture an electrode coating and coat one or both electrodes therewith.

The electrode coating has a thickness of greater than 1 μm, or even of greater than 3 μm, or even of greater than 5 μm and preferably less than 15 μm, or even of less than 10 μm, or even of less than 8 μm.

According to the invention, the oxide powder, very predominantly consisting of silica particles, has a specific surface area of less than 40 m²/g and greater than 5 m²/g.

Such powders are for example sold by Saint-Gobain under the names NS-950 and NS-980. Other silica powders may be suitable, for example the silica powders resulting from the silicon industry.

### EXAMPLES

The following examples are provided for illustrative purposes and do not limit the invention.

The chemical analysis was carried out on a powder calcined for 4 hours at 1000° C., by x-ray fluorescence as regards the constituents having a content of greater than 0.5%, the content of the constituents present in an amount of less than 0.5% was determined by ICP-AES (Inductively Coupled Plasma Atomic Emission Spectoscopy).

The measurement of the size of the particles of the powders and the percentiles 10, 50, 90 and 99.5 was carried out using a Partica LA-950 laser particle size analyzer from HORIBA.

The specific surface area of a powder was calculated by the BET (Brunauer Emmet Teller) method as described in The Journal of the American Chemical Society 60 (1938), pages 309 to 316.

The moisture content of a powder was determined by the following method: a mass mₗ of sample is weighed and placed in a dish for 4 hours in the oven. After this time period, the dish is removed from the oven and placed in a desiccator, containing for example a silica gel, so that the temperature of the powder contained in the dish decreases. The mass m₂ of the sample after drying is determined, at the latest 30 minutes after it is removed from the oven. The moisture content of the powder is then calculated as being equal to 100.(m₁−m₂)/m₁.

The corrosion resistance was measured by the following method: the powder to be tested is dried beforehand in an oven for 2 days at 110° C. 3 grams of said powder are then introduced into a Teflon container.

In a glove box under argon, the electrolyte that will be used to corrode the powder is prepared in the following manner:
25 g of lithium hexafluorophosphate LiFP₆ (“>99.99% Battery grade”, sold by Sigma-Aldrich) (LiFP₆ is an electrolyte commonly used in lithium-ion batteries),
109 g of ethylene carbonate and
88.2 g of dimethyl carbonate
   are introduced into an aluminum flask having a capacity equal to 300 ml. This mixture is stirred for 12 hours.

Still in the glove box, 15 g of said mixture are introduced into the Teflon container containing the powder to be tested. The Teflon container is sealed and placed in an oven at 75° C. for 14 days in order to simulate the extreme conditions of a battery.

At the end of these 14 days, the sample is recovered and the liquid phase is separated from the solid phase by simple decanting. Next, the liquid phase is filtered over a 0.45 μm filter to remove the fine powders from the electrolyte.

Next, 2 ml of this filtrate is recovered, which is placed in a 50 ml vial with also 2 ml of hydrochloric acid (in solution at 30% by mass) for the ICP assay. The electrolyte is also subjected to ICP measurement in order to serve as a measurement blank.

The calibration range of the ICP is carried out between 0 and 200 ppm. The element Si is assayed for each of the powders tested. The lower the amount of silicon found in the electrolyte, the higher the resistance of the powder tested to said electrolyte.

The sphericity index was determined from images of the powder obtained using a scanning electron microscope. The sphericity indices of at least 500 particles were determined, then the arithmetic mean of said indices was calculated in order to determine the sphericity index of the powder.

The following powders were tested:
The powder of comparative example 1 is a powder used in the separators of the prior art. It is an Aérosil 200 powder manufactured by Dégussa.
The powder of comparative example 2 is a powder used in the separators of the prior art. It is a Cabosil CT-1111G powder manufactured by Cabot.
The powder of example 3, intended to be used in a separation element according to the invention, is an NS-950 powder, sold by Saint-Gobain,
The powder of example 4, intended to be used in a separation element according to the invention, is an NS-980 powder, sold by Saint-Gobain.

Table 1 below summarizes the properties of the powders tested:

TABLE 1

| | Specific | Chemical analysis (%) | | | | | | | Moisture | |
|---|---|---|---|---|---|---|---|---|---|---|
| | surface area | | | | | | SiO₂ + Al₂O₃ + | | content | Sphericity |
| Ex. | (m²/g) | Al₂O₃ | Fe₂O₃ | Na₂O | SiO₂ | ZrO₂ | ZrO₂ | Others | (%) | index |
| 1 | 200 | <0.05 | — | — | >99.8 | — | >99.8 | <0.15 | 3.4 | 0.98 |
| 2 | 225 | <0.05 | <0.05 | — | >99.8 | — | >99.8 | <0.2 | 3.8 | 0.98 |
| 3 | 10 | 3.63 | 0.17 | 0.17 | 89.4 | 5.07 | 98.1 | 1.56 | 0.6 | 0.98 |
| 4 | 10 | 1.07 | 0.13 | 0.08 | 90.3 | 6.30 | 97.67 | 2.12 | 0.6 | 0.98 |

The amounts of silicon element measured in the electrolyte after the tests of resistance to corrosion by the electrolyte appear in table 2 below:

TABLE 2

| | Amount of silicon measured in |
|---|---|
| Example | the electrolyte after corrosion test (%) |
| 1 | 5.2 |
| 2 | 3.9 |
| 3 | 0.07 |
| 4 | 0.2 |

As the results in table 2 show, the silica powders of examples 3 and 4, used in the separation elements according to the invention, have, surprisingly, a resistance to corrosion in the LiFP₆ electrolyte that is much greater than that of the silica powders of examples 1 and 2, used in the separation elements of the prior art. The silica powder according to example 3 is the powder preferred out of all of them.

As is now clearly apparent, the invention thus provides a means for improving the resistance of a separation element of a lithium-ion battery to corrosion by the electrolyte, which makes it possible to improve the stability over time and the performances of the battery.

The oxide powders according to the invention used also have a lower rehydratability compared to that of the silica powders from the prior art (fumed silica, precipitated silica). This lower rehydratability thus limits the degradation of the electrolyte, the formation of hydrofluoric acid and the generation of gases in the battery, and therefore contributes to increasing the service life of the battery.

The rehydratability is the opposite to the difference in moisture content between an oxide powder dried at 100° C. for 4 hours and the same oxide powder after treatment for 96 hours in air at 35° C. and 80% humidity.

The rehydratability of the powders of the examples appears in table 3 below:

TABLE 3

| Example | Rehydratability (%) |
|---|---|
| 1 | 6.2 |
| 2 | 3.9 |
| 3 | 0.5 |
| 4 | 0.5 |

Furthermore, the oxide powders according to the invention used have a greater flowability than that of the silica powders from the prior art (fumed silica, precipitated silica). This greater flowability improves the handling and the dispersibility, and thereby the processability of these powders.

Finally, surprisingly, the use of powders according to the invention having a sphericity index of greater than 0.8 advantageously results in a more uniform distribution of the particles of said powders in the polymer of the separator.

Of course, the present invention is not limited to the embodiments described, provided by way of illustrative and nonlimiting examples.

1-15. (canceled)

16. A method of manufacturing a lithium-ion battery, comprising providing a separation element comprising a ceramic oxide powder having the following chemical analysis, as percentages on the basis of the mass of the ceramic oxides and for a total of 100%:
SiO₂>85%
Al₂O₃<10%
ZrO₂<10%
other ceramic oxides<5%,
said ceramic oxide powder having a specific surface area of less than 40 m²/g and greater than 5 m²/g,
said oxide powder having a sphericity index of greater than 0.8.

17. The method as claimed in claim 16, wherein said specific surface area is less than 30 m²/g.

18. The method as claimed in claim 17, wherein said specific surface area is less than 15 m²/g.

19. The method as claimed in claim 16, wherein said oxide powder has a moisture content, measured after drying at 100° C. for 4 hours, of less than 3%.

20. The method as claimed in claim 19, wherein said moisture content is less than 2%.

21. The method as claimed in claim 20, wherein said moisture content is less than 1%.

22. The method as claimed in claim 21, wherein said moisture content is less than 0.1%.

23. The method as claimed in claim 16, wherein the oxide powder has
an SiO₂+Al₂O₃+ZrO₂ content of greater than 90%, and/or
an SiO₂ content of greater than 87%, and/or
an Al₂O₃ content of greater than 0.2% and less than 8%, and/or
a ZrO₂ content of greater than 1% and less than 8%, and/or
a content of “other ceramic oxides” of less than 4%.

24. The method as claimed in claim 23, wherein the oxide powder has
an SiO₂+Al₂O₃+ZrO₂ content of greater than 95%, and/or
an SiO₂ content of greater than 89%, and/or
an Al₂O₃ content of greater than 2% and less than 6%, and/or
a ZrO₂ content of greater than 3% and less than 6%, and/or
a content of “other ceramic oxides” of less than 2%.

25. The method as claimed in claim 16, wherein less than 10% by mass of the silica of said oxide powder is crystalline.

26. The method as claimed in claim 16, wherein the oxide powder has a particle size distribution such that
D_{99.5}<10 μm, and/or
D₉₀<8 μm, and/or
D₅₀<2 μm, and/or
(D₉₀−D₁₀)/D₅₀<10.

27. The method as claimed in claim 26, wherein the oxide powder has a particle size distribution such that
D_{99.5}<5 μm, and/or
D₉₀<2 μm, and/or
D₅₀<0.5 μm, and/or
(D₉₀−D₁₀)/D₅₀<5.

28. A lithium-ion battery comprising a separation element obtained by a manufacturing process that applies the method as claimed in claim 16.

29. The battery as claimed in claim 28, wherein the separation element is selected from a separator, a separator film that is part of a separator consisting of a superposition of several films, a separator coated with one or more separator coatings, and an electrode coating.
